(19) United States
(12) Patent Application Publication
(10) Pub. No.: US 2018/0016832 A1
(43) Pub. Date: Jan. 18, 2018

(54) SOFT-CLOSE SYSTEM FOR SLIDING DOORS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 15/546,465

(22) PCT Filed: Jun. 2, 2016
(86) PCT No.: PCT/MX2016/000055

§ 371 Date: Jul. 26, 2017

(30) Foreign Application Priority Data
Sep. 21, 2015 (MX) MX/U/2015/000468

(51) Int. Cl. E05F 5/00; E05F 5/02; E05F 5/08; E05F 5/10

(52) U.S. Cl. CPC E05F 5/003; E05F 5/10; E05F 5/02; E05F 5/08

(57) ABSTRACT

A soft dosing sliding door system that includes a right and left attachment base, a hydraulic piston that is disposed on the right attachment base, a spring that is disposed on the left side attachment base. The system has an activator trigger that is disposed on the central part of the attachment base, a barrow body that includes a frontal body with four wheels, a back body with two wheels, two lateral arms that axially spreads out from the back part to the front part of the barrow body. The barrow body includes a primary mounting plate, a secondary mounting plate, and a 3 M long rail.

PREVIEWS OF THE INVENTION

CURRENTLY, THERE ARE A GREAT NUMBER OF SYSTEMS FOR SLIDING DOORS, HOWEVER, THE SAME DESIGNS ARE POORLY AESTHETIC DESIGNED, AN EXAMPLE IS THE CLOSING CLOSET DOOR SYSTEM WITH THE TRADITIONAL BASIC FUNCTIONS.

ANOTHER EXAMPLE IS THE SLIDING DOOR THAT HAVE TRACKS AND WHEELS THAT RUN ON THOSE TRACKS, A SLIDING DOOR SYSTEM THAT IS HOLD ON TOP BY A LATERAL MECHANISM DOORLOCK.

THE EXAMPLES MENTIONED ABOVE HAVE AS A LIMITATION THE POOR AESTHETIC, THAT ARE NOT REINFORCED WITH STRONG MATERIALS, THAT ARE NOISY, AND THAT THEY DO NOT HAVE SOFT CLOSING SYSTEM.

THESE LIMITATIONS HAVE AS A CONSEQUENCE, AS TIME PASSES BY, AND THE DAILY USE, THAT THE TOP HOLD TRACK SYSTEM LOOSENS UP, AND EVENTUALLY FALLS DOWN.

THIS INVENTION SEEKS TO RESOLVE THIS TECHNICAL PROBLEM BY ADDING A SOFT CLOSING SYSTEM FOR WOODEN SLIDING DOORS, A HIDDEN SYSTEM TO GIVE MORE AESTHETIC.

### DESCRIPTION OF THE INVENTION

THE NOVELTY OF THIS INVENTION IS SHOWN CLEARLY IN THE DRAWINGS THAT ARE SHOWN ALONG WITH THIS CURRENT APPLICATION, AND IN ACCORDING WITH THE DESCRIPTION THAT WE DESCRIBE.

THE ALPHA NUMERIC REFERENCES BELONG TO EACH ONE OF THE STRUCTURAL ELEMENTS THAT INTEGRATE THIS INVENTION.

### BRIEF DESCRIPTION OF THE FIGURES

FIG.#1 IS A VIEW OF THE DISASSEMBLE OF THE SLIDING DOOR SOFT CLOSING SYSTEM AND THE STRUCTURAL PARTS THAT BELONG IN THE SYSTEM.

FIG. #2 IS A VIEW OF THE DISASSEMBLE OF THE BARROW BODY AND THE STRUCTURAL PARTS THAT BELONG IN IT.

FIG. #3 IS A PERSPECTIVE VIEW OF THE ASSEMBLED BARROW BODY.

FIG. #4 IS A VIEW OF THE DISASSEMBLE OF THE MOUNTING PLATES AND THE STRUCTURAL PARTS THAT BELONG IN THEM.

FIG. #5 IS A PERSPECTIVE VIEW OF THE GUIDE.

FIG. #6 IS A PERSPECTIVE VIEW OF THE ACTIVATOR PLATE.

FIG. #7 IS A PERSPECTIVE VIEW OF BARROW BODY S FRONTAL ASSEMBLY ON THE GUIDE.

FIG. #8 IS A PERSPECTIVE VIEW OF PART OF THE RAIL.

FIG. #9 IS A PERSPECTIVE VIEW OF THE WHOLE SOFT CLOSING SLIDING DOORS SYSTEM ENSSEMBLE.

### INDETAILED DESCRIPTION OF THE INVENTION

WITH A REFERENCE TO FIG. #1, THE SOFT CLOSING SLIDING DOOR SYSTEM HAS A RIGHT BASE COUPLING (100)WITH TWO FRONTAL ENSSEMBLE HOLES (101) TWO BACK ENSSEMBLE HOLES (102) A LEFT BASE OF COUPLING (103)WITH TWO FRONTAL

ENSSEMBLE HOLES (104) TWO BACK ENSSEMBLE HOLES (105).

AN INTERNAL HYDRAULIC PISTON)106) THAT IS DISPOSED ON THE BASE OF THE RIGHT COUPLING (100).

A SPRING (107) THAT IS DISPOSED ON THE BASE OF THE LEFT COUPLING (103), AND AN ACTIVATOR TRIGGER (108) THAT IS DISPOSED ON THE CENTRAL PART OF THE BASES OF COUPLING.

WITH A REFERENCE TO FIG. #2, THE SOFT CLOSING SLIDING DOOR SYSTEM IS INTEGRATED AS, A FRONTAL BARROW BODY (109) WITH FOUR WHEELS, EACH ONE OF THESE IS ASSEMBLED WITH TWO COMPONENTS ON ITS MAIN BASE AND WEIGHT SUPPORT.

AN AUTO RIGID BEARING (110), THAT ALLOWS ADEQUATE RESISTANCE AND EASY OPERATION, AND A SECOND COMPONENT THAT CONSISTS OF A POLYETHYLENE (111) COVER THAT HELPS MINIMIZE THE NOISE ON THE BARROW BODY MOVEMENTS ALONG THE RAILS (FIG. #8).

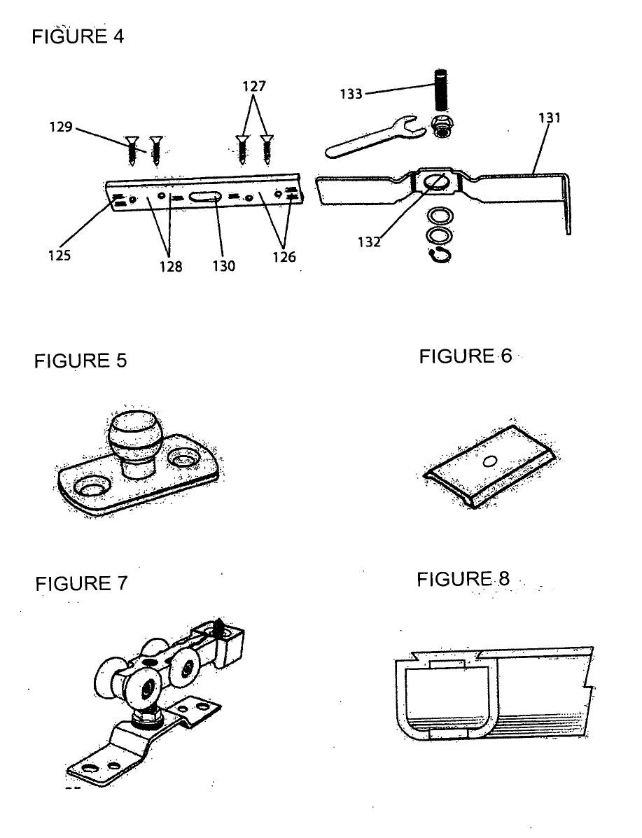

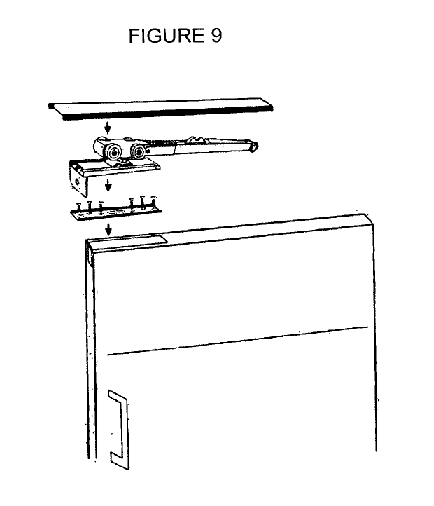

A HOLE IN THE CENTRAL ENSSEMBLE (112), AN ENSSEMBLE GUIDE (FIG. 5), A PLATE (FIG. 6) THAT ACTIVATES THE PISTON. A BACK BARROW BODY (113) WITH TWO WHEELS, A LATERAL RIGHT ARM (114) WITH HOLES IN THE FRONTAL ENSSEMBLE (115), A HOLE IN THE CENTRAL ENSSEMBLE (116) AND A BACK ENSSEMBLE (117), A LATERAL LEFT ARM (118) WITH FRONTAL ENSSEMBLE HOLES (119), A CENTRAL ENSSEMBLE HOLE (120) AND A BACK ENSSEMBLE HOLE (121), A FRONTAL ENSSEMBLE SCREW (122), A BACK ENSSEMBLE SCREW (123), THAT FORM AN COUPLING OPENING (124) THAT AXIALLY SPREADS OUT FROM THE BACK PART TO THE FRONT PART OF THE BARROW BODY (109) WHERE THE SOFT CLOSING SLIDING DOOR SYSTEM ATTACHES TO.

WITH A REFERENCE TO FIG. #4, THE SOFT CLOSING SLIDING DOOR SYSTEM INCLUDES A PRIMARY MOUNTING PLATE (125) WITH TWO RIGHT ENSSEMBLE HOLES (126), TWO FIXING SCREWS (127), TWO LEFT ENSSEMBLE HOLES (128), WITH TWO FIXING SCREWS (129) AND A CENTRAL ENSSEMBLE HOLE (130). THIS ENSEMBLE PLATE IS THE ONE THAT IS SET ON THE UPPER PART OF THE ENSSEMBLED DOOR. A SECONDARY MOUNTING PLATE (131) WITH A LATERAL ENSSEMBLE HOLE _NOT ILLUSTRATED_, A CENTRAL ENSSEMBLE HOLE (132), A SCREW WITH TWO PULLEYS (133), SUCH SECONDARY PLATE JOINS THE DOOR TO THE BARROW BODY. WITH A REFERENCE TO FIG. #8, THE SOFT CLOSING SLIDING DOOR SYSTEM INCLUDES A THREE METERS LONG ALLUMINUM RAIL, AND THREE ENSSEMBLE HOLES NOT ILLUSTRATED.

SOFT CLOSING SLIDING DOOR SYSTEM ENSSEMBLE.

THE SOFT CLOSING SLIDING DOOR SYSTEM ENSSEMBLES TO THE BARROW BODY THROUGH HOLES DISPOSED ON THE FRONTAL PART (101) AND BACK PART (104) OF THE RIGHT AND LEFT BASE OF THE SOFT CLOSING SYSTEM, AND THEY ARE FIXED WITH FRONTAL SCREWS (122), CENTRAL ONES_NOT ILLUSTRATED_, AND BACK ONES (123), DISPOSED ON THE RIGHT LATERAL ARM (114) AND LEFT LATERAL ARM (118) OF THE BARROW BODY.

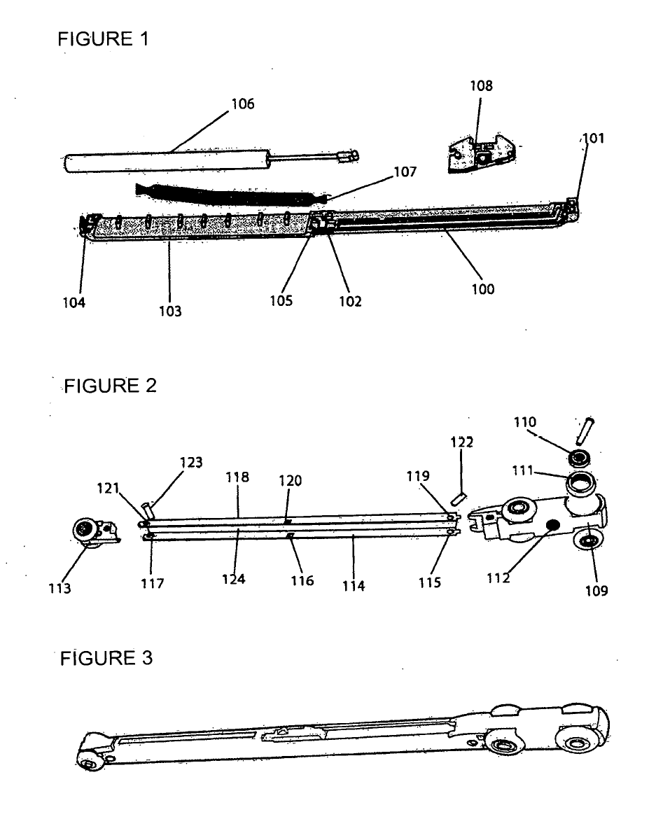

THE SOFT CLOSING SLIDING DOOR SYSTEM IS DESIGNED TO FUNCTION WITH UP TO 80 KG SLIDING DOORS, WHICH ALLOWS THE DOORS TO SLIDE QUIETLY AND SOFTLY OVER THE RAIL, AND ALLOWS A MUFFLED CLOSING THROUGH AN INTERNAL PISTON (106), ITS DESIGN ALLOWS THAT THE SYSTEM CAN BE INSTALLED ON DOORS FROM 90 CM WIDTH, THE COMPLETE SYSTEM INSTALLATION IS DONE INSIDE THE DOORWAY VANO, GIVING AESTHETICS, BECAUSE THE SYSTEM IS HIDDEN. THE BARROW BODY (FIG. 3), ONLY ALLOWS A SEPARATION BETWEEN THE DOOR AND THE TRACK FROM A 2 CM MINIMUM TO A 3.5 CM MAXIMUM. ITS DESIGN ALLOWS AN EASY HANDLING AND MOUNTING, SINCE ITS MOUNTING PLATES, THAT ARE IN BETWEEN INCLUDED TWO PIECES, WHICH ARE OF EASY TO ENSSEMBLE AND FIXING, THE PRIMARY PLATE (125) WHICH IS THE ONE THAT IS FIXED ON TO THE DOOR GIVING EASY DOOR HANDLING AT THE TIME OF ENSSEMBLE. THE SECONDARY PLAQUE (131), THAT ITS FUNCTION CONSISTS IN ATTACHING THE DOOR TO THE BARROW BODY THROUGH A SINGLE ENSSEMBLE SCREW (133). THE SIX WHEELS THAT ARE PART OF THE BARROW BODY ARE BUILT WITH TWO ELEMENTS IN ITS FRONTAL BASE (109) AND WEIGHT SUPPORT, WHICH HAS AS CHARACTERISTIC A CAR RIGID BEARING VALERO (110) THAT GIVES THE ADEQUATED RESISTANCE AND EASINESS TO THE SLIDING. THE SECOND ELEMENT CONSISTS OF A POLYETHILENE COVER (111) THAT HELPS THE BARROW BODY MOVEMENT TO HAVE A MINOR NOISE AMOUNT AS IT SLIDES THROUGH THE RAIL. THE SOFT CLOSING SLIDING DOOR SYSTEM_FIG. 1_{—} THAT IS INTEGRATED ONTO THE BARROW BODY, FIG. 3, THAT INCLUDES FIVE STRUCTURAL PARTS, WHICH HELP IN THE LAST 7.5 CM OF THE RAIL, TO HAVE SLOW AND MUFFLED CLOSING. SUCH A SYSTEM INCLUDES IN ITS MAIN PART AN INTERNAL PISTON (106) THAT PROVIDES A SOFT DISPLACEMENT OF THE SYSTEM, AND INCLUDES A SPRING (107) THAT FUNCTIONS AS AUXILIARY, SO THE DOOR HAS A PERFECT CLOSING IN THE END. THE SYSTEM HAS A ACTIVATOR TRIGGER (108) AND A RAIL THAT SUPPORTS ALL THE SYSTEM, THAT ALLOWS THE SYSTEM TO DISPLACE UNIFORMLY.

HAVING DESCRIBED IN A DETAILED MANNER OUR INVENTION, WE CONSIDER THAT IT IS A NOVELTY AND THEREFORE WE REQUEST THE INVENTION AS OUR EXCLUSIVE PROPERTY, WHICH IS CONTAINED IN THE FOLLOWING CLAIMS.

1. A soft closing sliding door system comprising:
a right attachment base with two frontal enssemble holes;
two back enssemble holes;
a left attachment base with two frontal enssemble holes;
two back enssemble holes;
an internal hydraulic piston that is disposed on the right attachment base;
a spring that is disposed on the left attachment base;
an activator trigger that is disposed on the central part of the two attachment bases.

2. A soft closing sliding door system according to claim 1, further comprising:
a frontal barrow body with four wheels;
a central enssemble hole;
an enssemble guide;
a plate that activates the piston;
a back barrow body with two wheels;
a right lateral arm with frontal enssemble holes;
central enssemble holes;
back enssemble holes;
a left lateral arm with frontal enssemble holes;
central enssemble holes;
back enssemble holes;
a frontal enssemble screw;
a back dissemble screw; and
an attachment opening that spreads out axially from the back part to the front part of the barrow body.

3. A soft closing sliding door system according to claim 2, further comprising:
a car rigid bearing on each one of the wheels.

4. A soft dosing sliding door system according to claim 2, further comprising:
a polyethylene cover on each one of the wheels.

5. A soft closing sliding door system in according to claim 2, further comprising:
a guide.

6. A soft closing sliding door system in according to claim 2, further comprising:
a piston activator plate.

7. A soft closing sliding door system comprising:
a primary enssemble plate with two right enssemble holes;
two fixing screws;
two left dissemble holes with two fixing screws; and
a central enssemble hole.

8. A soft closing sliding door system according to claim 6, further comprising:
a secondary mounting plate with an dissemble hole;
a central enssemble; and
a screw with two pulleys.
